(19) United States
(12) Patent Application Publication
(10) Pub. No.: US 2007/0145955 A1
(43) Pub. Date: Jun. 28, 2007

(54) System for detecting battery voltage with high precision

(75) Inventors: David Ho, Taipei (TW); Tao Xia, Shanghai City (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/588,367

(22) Filed: Oct. 27, 2006

(30) Foreign Application Priority Data
Dec. 26, 2005 (TW) 094146479

(51) Int. Cl. H02J 7/00

(52) U.S. Cl. 320/166

(57) ABSTRACT

The present invention discloses a system for detecting a battery voltage with high precision, of which a RC filter circuit or a PI type circuit is applied to a handheld hardware device for eliminating the effect of a power noise on a battery voltage detector of the handheld device, while an appropriate weight algorithm is used with the software of the handheld device, such that a conditional determination can be added to a remaining battery capacity parameter to compensate the effect of the fluctuated battery voltage caused by the consumed current, so as to detect the battery voltage with a high precision and allow users to determine the using time of the handheld device accurately.

### FIELD OF THE INVENTION

The present invention relates to a system for detecting a battery voltage, and more particularly to a system implemented to a handheld device for detecting a battery voltage provided by a battery installed therein with high precision so as to allow users to determine the using time of the handheld device accurately.

### BACKGROUND OF THE INVENTION

In recent years, handheld devices such as mobile phones come with diversified functions, and many mobile phones include value-added functions such as MP3 and electronic dictionary, etc. However, the addition of these functions definitely consumes more power of the mobile phones, and the current mobile phones cannot effectively reduce the power consumption of battery. Undoubtedly, the diversified functions of the present mobile phones add more fun and convenience to a mobile phone, but also exhaust the battery power of the mobile phones very often, and thus creating concerns of using the functions of the mobile phones.

In addition, the handheld devices such as mobile phones usually rely on the detection of battery voltage to confirm its remaining battery capacity, and thus the precision of the obtained battery voltage can determine whether or not the estimated using time of the handheld device is accurate.

As described above, the power consumption of the battery varies with the use, function and mode of the handheld device, and thus the battery voltage may be fluctuated. Similarly, a system power noise (a noise is generally defined as a useless portion of the signal; for instance, if the frequency of a processing signal is 20 KHz and the system is mixed with a signal of 50 KHz, then the signal of 50 KHz is considered as a noise) also will affect the accuracy of the battery voltage.

Referring to FIG. 1, the hardware of a traditional handheld device uses a capacitor C1 only, and the capacitor C1 is connected to a battery V_BAT and the pins of a voltage detection chip 10, wherein the capacitor C1 is provided for filtering a high frequency noise (which is called “decoupling”), and the voltage detection chip 10 is provided for detecting the battery voltage supplied by the battery V_BAT. However, the foregoing system cannot eliminate the influence of the system power noise on the hardware detection of voltage of the battery V_BAT. Basically, the fluctuation of the system voltage varies directly with the fluctuation of the voltage of the battery V_BAT detected by the voltage detection chip 10, and thus the result of the measured battery voltage is inaccurate and unstable.

Therefore, designing a system for detecting a battery voltage with high precision to accurately determine the using time of the handheld device definitely can improve the selling price and provide better business opportunity for handheld devices and also bring tremendous convenience to users as well.

### SUMMARY OF THE INVENTION

In view of the foregoing shortcomings of the traditional way of detecting a battery voltage provided by a battery such as its inaccuracy and instability that affects the determination of the using time of the handheld device, the inventor of the present invention based on years of experience in the related industry to conduct extensive researches and experiments, and finally developed a system for detecting a battery voltage with high precision, in hope of overcoming the shortcomings of the prior art by the innovative idea of the present invention.

Therefore, it is a primary objective of the present invention is to provide a system for detecting a battery voltage with high precision, and the system is applied to the hardware of a handheld device for utilizing a RC filter circuit or a PI type circuit on the hardware of a handheld device to eliminate the effect of a power noise on a battery voltage detector of the handheld device, while an appropriate weight algorithm is used with the software of the handheld device, such that a conditional determination can be added to a remaining battery capacity parameter to compensate the effect of the fluctuated battery voltage caused by the consumed current, so as to detect the battery voltage with high precision and allow users to determine the using time of the handheld device accurately.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

FIG. 1 is a schematic view of detecting hardware of a prior art;

FIG. 2 is a schematic view of a RC filter circuit of the present invention; and

FIG. 3 is a schematic view of a PI type circuit in accordance with the present invention.

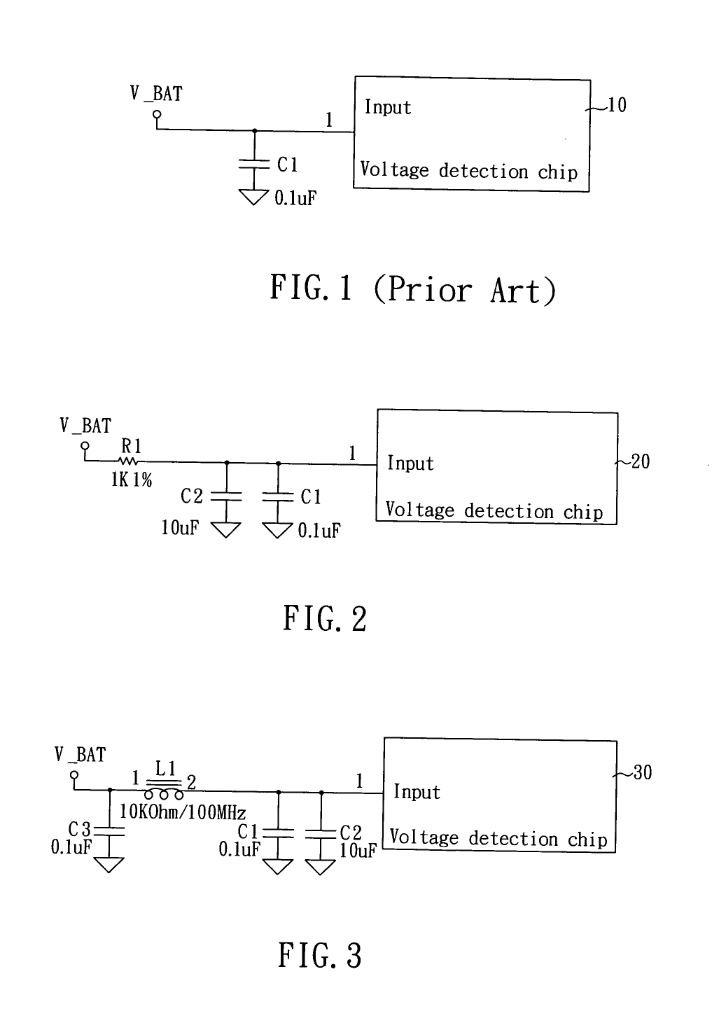

### DETAILED DESCRIPTION OF THE PREFERRED EMBODIMENTS

Referring to FIG. 2 for a system for detecting a battery voltage with high precision in accordance with a preferred embodiment of the present invention, the system uses a RC filter circuit on the hardware of a handheld device, and the RC filter circuit includes a first capacitor C1, and the first capacitor C1 of the invention is a small capacitor for filtering a high frequency power noise (a noise is generally defined as a useless portion of the signal; for instance, if the frequency of a processing signal is 20 KHz and the system is mixed with a signal of 50 KHz, then the signal of 50 KHz is considered as a noise) will affect the accuracy of the battery voltage. Further, the first capacitor C1 is connected to a battery V_BAT and the pins of a voltage detection chip 20, and the voltage detection chip 20 is provided for detecting voltage of the battery V_BAT, and a second capacitor C2 and a resistor R1 are connected between the first capacitor C1 and the battery V_BAT. The resistor R1 is connected between the battery V_BAT and the second capacitor C2, and the second capacitor C2 of the invention is a large capacitor, for reducing a larger instant fluctuation of the battery voltage of the battery V_BAT, and the resistor R1 can greatly reduce the power noises of different frequencies in a system.

If the fluctuation of the voltage of the battery V_BAT of a system is 50 mV, the fluctuation of a voltage passing through the RC filter circuit can be reduced to 20 mV; and thus the foregoing RC filter circuit can lower the percentage of a ripple voltage of an output terminal and a DC voltage. In other word, the ripples can be reduced to achieve the filtering effect.

Referring to FIG. 3 for another preferred embodiment of the present invention, the system further comprises the steps of using a Pi type circuit on the hardware of a handheld device, and the PI type circuit has a first capacitor C1, and the first capacitor C1 is connected to a battery V_BAT and the pins of a voltage detection chip 30, and the voltage detection chip 30 is provided for detecting the voltage of the battery V_BAT; a second capacitor C2 is connected between the first capacitor C1 and the pins of the voltage detection chip 30, and the second capacitor C2 of the present invention is a large capacitor for reducing a larger instant fluctuation of the voltage of the battery V_BAT. Further, a third capacitor C3 is connected between the first capacitor C1 and the battery V_BAT, and an inductor L1 is installed between the first capacitor C1 and the third capacitor C3. With the PI type circuit comprised of the first capacitor C1, the inductor L1 and the third capacitor C3, the present invention can eliminate the power noises of different frequencies in a system, so as to improve the overall precision for detecting the voltage of the battery V_BAT.

In addition, another preferred embodiment of the present invention adopts an appropriate weight algorithm on the software of the handheld device to obtain the battery voltage more accurately, and the actual codes for the weight algorithm are given as follows:

The following codes are added to the parameter of a remaining battery capacity:

```
If (GHwrBatteryPrecent)
    oldValue=GHwrBatteryPercent;
  else
    oldValue=currentPercent;
```

where, the foregoing codes illustrates a conditional determination, such that if the battery capacity measured at a previous time is non-zero, the value of the battery capacity of the previous time is assigned with oldvalue; and if the value of battery capacity measured at a previous time is zero, then a value currentPercent currently sampled by the voltage detection chip 20, 30 (as shown in FIGS. 2 and 3) will be assigned to the battery;

average=(oldValue<<1)+oldValue+currentPercent;

average=(average+4)>>2;

where, the foregoing codes illustrates that three old values and one current value are added and the sum is divided by 4 to compute an average and obtain the desired displaying remaining batter capacity, and the currently sampled value currentPercent carries a weight of one-quarter;

```
if (currentPercent>oldValue+10)
  average=currentPercent;
//If new value much less than current average, force it into
average if (currentPercent<oldValue−10)
  average=currentPercent;
```

where, the foregoing code illustrates that if a user has not turned on a display screen of the handheld device for a long time, and the screen display is turned on for the first time, and the voltage of the battery V_BAT is much larger than (exceeding 10%) that of the previous shutdown, a jump of the remaining battery capacity will be displayed.

With the foregoing RC filter circuit or the PI type circuit, the influence of the power noise on the detection of the hardware by the battery voltage can be reduced. In the meantime, an appropriate weight algorithm of the software is adopted to compensate the effect of the fluctuated battery voltage caused by the consumed current, so as to detect the battery voltage with high precision and allow users to determine the using time of the handheld device accurately. In addition, the software allows the display of a jump of the remaining battery capacity.

While the invention herein disclosed has been described by means of specific embodiments, numerous modifications and variations could be made thereto by those skilled in the art without departing from the scope and spirit of the invention set forth in the claims.

What is claimed is:

1. A system for detecting a battery voltage with high precision, which is applied to a handheld device having a battery and a voltage detection chip for detecting battery voltage of said battery, comprising:
a first capacitor for filtering a high-frequency power noise of said battery voltage, where one end of said first capacitor is connected between said voltage detection chip and said battery;
a second capacitor for lowering a larger instant fluctuation of said battery voltage, where one end of said second capacitor is connected between said one end of said first capacitor and said battery; and
a resistor for reducing power noises at different frequencies, where said resistor is connected between said one end of said second capacitor and said battery;
wherein said first capacitor, said second capacitor and said resistor form a RC filter circuit.

2. The system for detecting a battery voltage with high precision of claim 1, wherein said first capacitor is a small capacitor.

3. The system for detecting a battery voltage with high precision of claim 1, wherein said second capacitor is a large capacitor.

4. The system for detecting a battery voltage with high precision of claim 1, further comprising:
an appropriate weight algorithm for adding a conditional determination to a parameter of a remaining battery capacity detected by said voltage detection chip;
an old value being assigned to a previous detected battery capacity when said previous detected battery capacity is non-zero; and
a value currently sampled by said voltage detection chip being assigned to said previous detected battery capacity when said previous detected battery capacity is zero.

5. The system for detecting a battery voltage with high precision of claim 4, wherein said conditional determination further comprises an average of three old values and one current value obtained for displaying said remaining battery capacity, where said currently sampled value has a weight of one-quarter.

6. The system for detecting a battery voltage with high precision of claim 4, wherein said conditional determination further comprises a jump of said remaining battery capacity displaying on a display screen of said handheld device, if said display screen has not been turned on for a long time, and is then turned on with said battery voltage having a large difference from that of a previous shutdown.

7. A system for detecting a battery voltage with high precision, which is applied to a handheld device having a battery and a voltage detection chip for detecting battery voltage of said battery, comprising:
a first capacitor of said PI type circuit, where one end of said first capacitor is connected between said voltage detection chip and said battery;
a second capacitor for reducing an instant fluctuation of a larger battery voltage provided by said battery, where one end of said second capacitor is connected between said first capacitor and said voltage detection chip;
a third capacitor, where one end of said third capacitor is connected between said first capacitor and said battery; and
an inductor coupled between said one end of said first capacitor and said one end of said third capacitor;
wherein said first capacitor, said inductor and said third capacitor form a PI type circuit capable of eliminating power noises of different frequencies.

8. The system for detecting a battery voltage with high precision of claim 7, wherein said second capacitor is a large capacitor.

9. The system for detecting a battery voltage with high precision of claim 7, further comprising:
an appropriate weight algorithm for adding a conditional determination to a parameter of a remaining battery capacity detected by said voltage detection chip;
an old value being assigned to a previous detected battery capacity when said previous detected battery capacity is non-zero; and
a value currently sampled by said voltage detection chip being assigned to said previous detected battery capacity when said previous detected battery capacity is zero.

10. The system for detecting a battery voltage with high precision of claim 9, wherein said conditional determination further comprises an average of three old values and one current value for displaying said remaining battery capacity, where said currently sampled value has a weight of one-quarter.

11. The system for detecting a battery voltage with high precision of claim 9, wherein said conditional determination further comprises a jump of said remaining battery capacity displaying on a display screen of said handheld device, if said display screen has not been turned on for a long time, and is then turned on with said battery voltage having a large difference from that of a previous shutdown.
